(19) United States
(12) Patent Application Publication
(10) Pub. No.: US 2022/0064376 A1
(43) Pub. Date: Mar. 3, 2022

(54) STAIN RESISTANT POLYAMIDE POLYMERS OBTAINED VIA HIGH END GROUP TERMINATION

(71) Applicant: AdvanSix Resins & Chemicals LLC, Parsippany, NJ (US)

(72) Inventors: David J. Loy, Richmond, VA (US); Haoyu Liu, Midlothian, VA (US); Timothy Bauer, Parsippany, NJ (US)

(21) Appl. No.: 17/291,512

(22) PCT Filed: Oct. 23, 2019
(86) PCT No.: PCT/US2019/057653

§ 371 Date: May 5, 2021

Related U.S. Application Data
(60) Provisional application No. 62/758,036, filed on Nov. 9, 2018.
(60) Provisional application No. 62/836,813, filed on Apr. 22, 2019.

(51) Int. Cl. C08G 69/14; C08G 69/48; D01D 5/08; D01D 5/16; D01F 6/60

(52) U.S. Cl. CPC C08G 69/14; C08G 69/48; D01D 5/08; D10B 2503/04; D01F 6/60; D10B 2331/02; D01D 5/16

(57) ABSTRACT

The present disclosure provides fibers and filaments formed from polyamide polymers polymerized with dual termination of the amino and carboxyl end-groups, referred to herein as dual-terminated polyamides, or dual terminated PA. In one embodiment, the dual-terminated polyamide is considered “highly terminated” and is useful in producing stain resistant textiles such as carpet fibers, for example.

### CROSS-REFERENCE TO RELATED APPLICATIONS

This application is a U.S. 371 National Stage Application of International Application No. PCT/US2019/057653, filed 23 Oct. 2019, which claims priority to U.S. Provisional Application No. 62/758,036, filed Nov. 9, 2018, and U.S. Provisional Application No. 62/836,813, filed Apr. 22, 2019, all of which are herein incorporated by reference in their entireties.

### FIELD

The present invention relates to materials, methods, and apparatus for producing polyamide polymers and, in particular, for producing stain resistant polyamide polymers for color pigmented textile or carpet fibers via high termination of the end groups of the polyamide polymers.

### BACKGROUND

Typical polyamide-6 polymers are polymerized with mono-termination using a di-functional acid, which reacts with, and therefore terminates, the amine end groups of the polymers. Typical polyamide polymers include polyamide-6 (PA-6), polyamide-6,6 (PA-66), polyamide-666 (PA-666), polyamide-46 (PA-46), polyamide-610 (PA-610), and polyamide-1212 (PA-1212) polymers.

U.S. Patent Application Publication No. 2017/0183796 entitled DUAL-TERMINATED POLYAMIDE FOR HIGH SPEED SPINNING APPLICATION, filed Dec. 22, 2016, discloses dual termination of polyamide polymers intended for high speed spinning applications. The application discloses an amine end group concentration range between 25 mmol/kg to 40 mmol/kg or 25 mmol/kg or lower and a carboxyl end group concentration range between 18 mmol/kg to 50 mmol/kg or 65 mmol/kg or lower, and the application exemplifies amine end group concentrations of 34.9 mmol/kg and 27.4 mmol/kg and carboxyl end group concentrations of 24.7 mmol/kg and 21.7 mmol/kg in the Examples.

Alterations in the end group concentrations may yield different properties for the resulting dual terminated polyamide polymers.

### SUMMARY

The present disclosure provides fibers and filaments formed from polyamide polymers that are dual-terminated at both the amino and the carboxyl end-groups, referred to herein as dual-terminated polyamides, or dual terminated PA. The dual-terminated polyamide polymers described herein may be “highly terminated” and are useful in producing stain resistant textiles such as carpet fibers, for example.

The present disclosure provides a polyamide polymer having amine end groups and carboxyl end groups, the polyamide polymer further including an amine end group concentration less than 20 mmol/kg; a carboxyl end group concentration less than 20 mmol/kg; and a formic acid viscosity (FAV) of at least 40 as measured according to ASTM D-789.

The polyamide polymer may have an amine end group concentration of between 8 mmol/kg and 20 mmol/kg and/or a carboxyl end group concentration of between 6 mmol/kg and 20 mmol/kg.

The polyamide polymer may have a formic acid viscosity (FAV) of at least 50 as measured according to ASTM D-789, or the polyamide polymer may have a formic acid viscosity between 40 and 90 as measured according to ASTM D-789.

The polyamide polymer may have an extractables content of less than 1.0 wt. % as measured according to ISO 6427.

The polyamide polymer may have a ΔE according to AATCC Test Method 175-08 of less than 10. The polyamide polymer may be polycaprolactam.

The present disclosure also provides a method of forming a polyamide polymer fiber, including the steps of providing a polyamide polymer having amine end groups and carboxyl end groups, the polyamide polymer further including an amine end group concentration less than 20 mmol/kg; a carboxyl end group concentration less than 20 mmol/kg; and a formic acid viscosity (FAV) of at least 40 as measured according to ASTM D-789; and spinning the polyamide polymer at a spinning speed of at least 2,500 m/min to form a plurality of fibers.

The spinning step may include spinning the polyamide polymer at a spinning speed of between 2,500 m/min and 5,000 m/min to form a plurality of fibers.

The fibers may have a ΔE according to AATCC Test Method 175-08 of less than 22. The polyamide polymer of the providing step is polycaprolactam.

The polyamide polymer may have an amine end group concentration of between 8 mmol/kg and 20 mmol/kg and/or a carboxyl end group concentration of between 6 mmol/kg and 20 mmol/kg.

The polyamide polymer may have a formic acid viscosity between 40 and 90 as measured according to ASTM D-789 and/or an extractables content of less than 1.0 wt. % as measured according to ISO 6427.

The above mentioned and other features of the invention, and the manner of attaining them, will become more apparent and the invention itself will be better understood by reference to the following description of embodiments of the invention taken in conjunction with the accompanying drawings.

### BRIEF DESCRIPTION OF THE DRAWINGS

FIG. 1A illustrates an example of a method of producing terminated and non-terminated polyamide (PA) polymers.

FIG. 1B illustrates an example of a system for producing fibers or filaments.

FIG. 2 illustrates an example of a system for extrusion, spinning, and drawing fibers or filaments.

Corresponding reference characters indicate corresponding parts throughout the several views. The exemplifications set out herein illustrates various aspects of the invention and such exemplifications are not to be construed as limiting the scope of the invention in any manner.

### DETAILED DESCRIPTION

Although the fibers and filaments exemplified below are formed from dual-terminated PA-6 polymers, the disclosure is not intended to be limited to only dual-terminated PA-6 polymers. Fibers and filaments according to the present disclosure may also be formed from other dual terminated polyamide polymers, including, for example, polyamide-6 (PA-6), polyamide-6,6 (PA-66), polyamide-666 (PA-666), polyamide-46 (PA-46), polyamide-610 (PA-610), polyamide-1212 (PA-1212), and mixtures and copolymers thereof.

Although not so limited, the dual-terminated polyamide polymers described herein are particularly useful in forming stain resistant polymers for color pigmented carpet fiber applications.

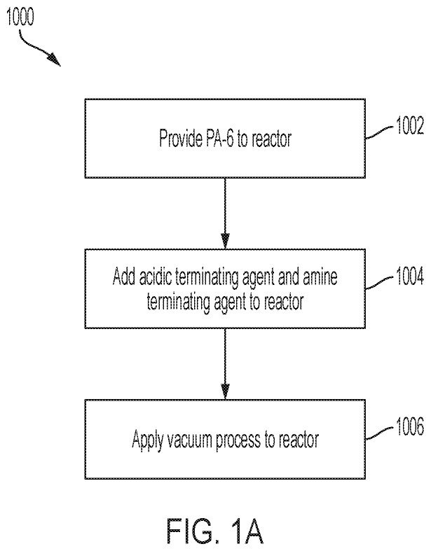

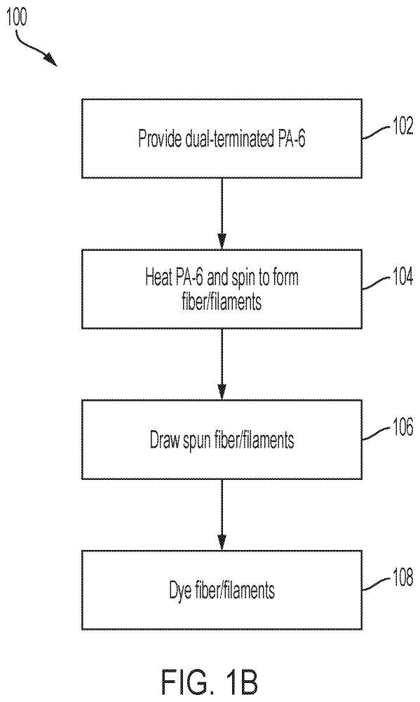

Referring first to FIG. 1A, an example of a method 1000 of producing a dual terminated polyamide is shown. In method 1000, ε-caprolactam may be used and/or other polyamides be used to make a dual-terminated polyamide of this disclosure. As shown in block 1002, ε-caprolactam, 0.5-2% water, acidic terminating agents and/or amine terminating agents are provided to a reactor. The reactor may be a batch reactor. While ε-caprolactam is in the reactor, it undergoes hydrolysis as shown in the reaction schematic below.

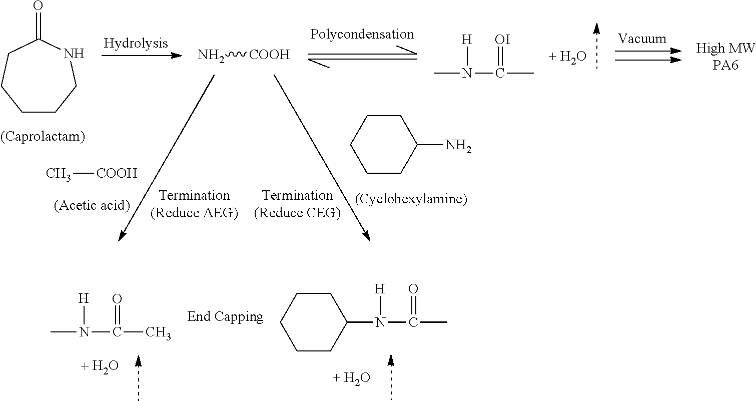

During hydrolysis, the added acidic terminating agents and/or amine terminating agents respectively terminate the available amine and carboxyl end groups as shown in block 1004. As shown in the reaction schematic above, acetic acid and cyclohexylamine may be added to the reactor, however, it is within the scope of the present disclosure that other acidic terminating agents and amines may also be suitable and used in a like manner.

Examples of amine end group terminators include acidic terminators such as mono-functional acids, and examples of carboxyl end group terminators include amines such as, for example, mono-functional amines. In this manner, an acidic terminator is used to terminate the amine (NH₂) end groups, whereas an amine is used to terminate the carboxyl (—COOH) end groups of the polyamide polymer.

Examples of amine end group terminating agents include acids such as acetic acid, propionic acid, benzoic acid, stearic acid, and/or terephthalic acid, and examples of carboxyl end group terminating agents include monofunctional amides, such as cyclohexylamine and benzylamine and polyether amines. Increased levels of terminating agents added to the PA resin would lower the end group concentrations of reactive amine and/or carboxyl end groups.

As shown in the reaction schematic above, water is produced in the polycondensation reaction. A water removal process is applied via nitrogen (N₂) injection, and/or a vacuum process may be applied as shown in block 1006. A pressure or vacuum process is introduced to remove excess water, and in doing so, the equilibrium of the polycondensation reaction is driven to the products side (i.e., the right), resulting in a greater extent of polymerization for the polyamide polymer. Maximum gas addition or vacuum is used to drive, as much as possible, the equilibrium of the polycondensation reaction continuously to the right, thereby achieving polyamide polymers having a greater extent of polymerization.

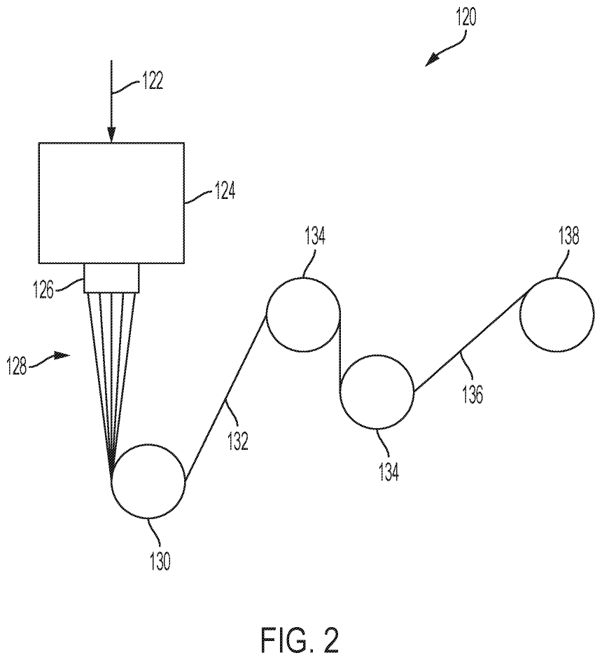

Referring now to FIGS. 1A and 2, an example of a method 100 of producing spun fibers is illustrated. As shown in block 102, a dual terminated polyamide resin, such as PA-6 resin, is provided. FIG. 1B provides an example of a system 102, producing a fiber from such a dual-terminated polyamide resin. The dual-terminated polyamide resin shown in these figures includes different terminators for the amine (—NH₂) end groups and carboxyl (—COOH) end groups of the resin. In practice, the terminators for the amine end groups and carboxyl end groups may be chemically distinct.

As illustratively shown in FIGS. 1B and 2, a dual-terminated PA-6 resin is provided as a feed 122 to the hopper of an extruder 124, then melted in the extruder and pumped out through the spinneret 126 as fibers 128. Referring next to FIG. 1B in block 104, a dual-terminated PA-6 resin is heated and spun into a fiber. In FIG. 2, a heated, dual-terminated PA-6 resin is spun using a spinneret 126, which may include one or more outlets for forming individual fibers 128 with a round or delta cross section. The individual fibers 128 may then be collected at 132 and drawn over one or more drawing rollers 134 before the resulting fibers 136 are collected in a wind-up bobbin 138 (as textiles and carpet fibers).

Referring again to FIG. 1B, in block 106, the spun fiber may be subjected to one or more drawing steps (with and without a texturing device). For example, the fiber may be totally drawn (from spinneret to wind-up as melt draw down and mechanical fiber draw) as little as 90×, 100×, 110×, as great as 230×, 240×, 250×, or within any range defined between any two of the foregoing values, such as 90× to 250×, 100× to 240×, or 110× to 230×. The ratio is the total draw ratio for the fibers, from spinneret to wind-up. For example, the fibers 136 may have an elongation of 30%, 40%, 50%, or even as much as 70%, 80%, 90%, or within any range defined between any two of the foregoing values, such as 30% to 90%.

In the same FIG. 1B, block 106, the spun fibers may be wound up to form a bobbin. For example, each fiber may contain as few as 30, 32, 34, or as many as 56, 58, 60, filaments, or within any range defined between any two of the foregoing values, such as 30 to 60, 32 to 58, or 34 to 56 filaments, for example. The fibers may have a total denier of 150, 165, 180, or even as high as 1400, 1450, 1500, or within any range defined between any two of the foregoing values, such as 150 to 1500, 165 to 1450, or 180 to 1400 denier, for example. The denier per filament may be 4, 5, 6, or as high as 46, 48, 50, or within any range defined between any two of the foregoing values, such as between 4 and 10 denier for textile applications or between 22 and 28 denier for carpet applications, for example.

The dual-terminated polyamide resin (e.g., a PA-6 resin) may include a carboxyl end terminating agent in an amount of as little as 0.01 wt. %, 0.05 wt. %, 0.10 wt. %, as great as 0.40 wt. %, 0.45 wt. %, 0.50 wt. %, or within any range defined between any two of the foregoing values, such as 0.01 wt. % to 0.5 wt. %, 0.05 wt. % to 0.45 wt. %, or 0.10 wt. % to 0.40 wt. %, for example, with respect to the total composition of the dual-terminated resin, and an amine end terminating agent in an amount of as little as 0.20 wt. %, 0.25 wt. %, 0.30 wt. %, as great as 0.60 wt. %, 0.65 wt. %, 0.70 wt. %, or within any range defined between any two of the foregoing values, such as 0.20 wt. % to 0.80 wt. %, 0.25 wt. % to 0.65 wt. %, or 0.30 wt. % to 0.6 wt. %, for example, with respect to the total composition of the dual-terminated resin, for example. “Total composition” as used herein refers to the monomeric starting materials used to make the dual-terminated polymeric resin, excluding other components that may be in the reactor. For example, for a dual-terminated PA-6, the total composition shall refer to ε-caprolactam. For a dual-terminated PA-6, 6, the total composition shall refer to hexamethylene diamine and adipic acid.

The polymerized polyamide polymer of the present disclosure includes both amine end groups and carboxyl end groups.

The amine end group (AEG) concentration can be determined by the amount of hydrochloric acid (HCl standardized, 0.1 N) needed to titrate a sample of the polyamide in 70% phenol/30% methanol according to the formula:

(mL HCl to titrate sample−mL HCl to titrate blank)×(Normality of HCl)×1000 Sample weight (g)

For example, a dual-terminated PA-6 resin may have an amine end group concentration of 25 mmol/kg or less, 22 mmol/kg or less, 20 mmol/kg or less, or 18 mmol/kg or less, or as low as 10 mmol/kg or less, 8 mmol/kg or less, 7 mmol/kg or less, or as low as 5 mmol/kg, or the dual-terminated PA-6 resin may have an amine end group concentration that is within any range defined between any two of the foregoing values, such between 5 mmol/kg and 25 mmol/kg, between 7 mmol/kg and 22 mmol/kg, or between 8 mmol/kg and 20 mmol/kg, for example.

The carboxyl end group (CEG) concentration can be determined by the amount of potassium hydroxide (KOH) needed to titrate a sample of the polyamide in benzyl alcohol according to the formula:

(mL KOH to titrate sample−mL KOH to titrate blank)×(Normality of KOH)×1000 Sample weight (g)

For example, a dual-terminated PA-6 resin may have a carboxyl end group concentration of 25 mmol/kg or less, 22 mmol/kg or less, 20 mmol/kg or less, or 18 mmol/kg or less, or as low as 10 mmol/kg or less, 7 mmol/kg or less, 6 mmol/kg or less, or as low as 5 mmol/kg, or the dual-terminated PA-6 resin may have a carboxyl end group concentration that is within any range defined between any two of the foregoing values, such as between 5 mmol/kg and 25 mmol/kg, between 6 mmol/kg and 22 mmol/kg, or between 10 mmol/kg and 20 mmol/kg, for example.

The dual-terminated PA-6 resin may have a total end group concentration (amine end groups+carboxyl end groups) of as high as 50 mmol/kg, 45 mmol/kg, 40 mmol/kg, 35 mmol/kg, or as low as 20 mmol/kg, 15 mmol/kg, 10 mmol/kg or lower, or within any range defined between any two of the foregoing values, such as 50 mmol/kg to 10 mmol/kg, 45 mmol/kg to 10 mmol/kg, 22 mmol/kg or lower, 20 mmol/kg or lower, or 10 mmol/kg or lower, for example.

Another way to measure levels of termination in a linear polymer is by the degree of termination. The degree of termination of a dual-terminated PA resin can be determined using the following formulas:

$$\% Total termination = [ \frac{\begin{matrix}Equilibrium NH 2 + COOH ends for FAV level - \\ Terminated NH 2 + COOH ends\end{matrix}}{Equilibrium NH 2 + COOH ends for FAV level} ] * 100 \%$$

$$\% NH 2 termination = [ \frac{\begin{matrix}Equilibrium NH 2 ends for FAV level - \\ Terminated NH 2 ends\end{matrix}}{Equilibrium NH 2 ends for FAV level} ] * 100 \% \\ \% COOH termination = [ \frac{\begin{matrix}Equilibrium COOH ends for FAV level - \\ Terminated COOH ends\end{matrix}}{Equilibrium COOH ends for FAV level} ] * 100 \%$$

A polymer that is highly dual terminated can have a % Total termination of as low as 40%, 45%, 50% or as high as 75%, 80%, 85%, or within any range defined between any two of the foregoing values, such as 40% to 85%, 45% to 80%, or 50% to 75%, for example. A polymer that is maximally dual terminated (or has maximum dual termination) can have a % Total termination of 65% or greater, 70% or greater, or even 75% or greater. For example, a polymer that is maximally dual terminated can have a % Total termination of as low as 65%, 70%, 75%, or as high as 99%, 99.5%, 99.9%, or within any range defined between any two of the foregoing values, such as 65% to 99.9%, 70% to 99.5%, or 75% to 99%, etc.

A dual-terminated polyamide polymer of the present disclosure can have a degree of termination or % Total Termination of as low as 30%, 40%, 50%, or as high as 70%, 80%, 90%, or within any range defined between any two of the foregoing values, such as 30% to 90%, for example.

A dual-terminated PA resin of the present disclosure may have a % NH2 termination of as low as 30%, 40%, 50%, or as high as 70%, 80%, 90%, or within any range defined between any two of the foregoing values, such as 30% to 90%, for example.

A dual-terminated PA resin of the present disclosure may have a % COOH termination of as low as 30%, 40%, 50%, or as high as 70%, 80%, 90%, or within any range defined between any two of the foregoing values, such as 30% to 90%, for example.

A dual-terminated PA resin of the present disclosure may have a relative viscosity (RV), measured according to GB/T 12006.1-2009/ISO 307:2007 of as low as 2.05 RV, 2.3 RV, 2.6 RV, or as high as 3.0 RV, 3.25 RV, 3.4 RV, or within any range defined between any two of the foregoing values, such as 2.05 RV to 3.4 RV to 2.6 RV, or 2.6 RV to 3.0 RV, for example. An example of a dual-terminated PA-6 resin of the disclosure may have a relative viscosity of 2.7 RV.

A dual-terminated PA resin of the present disclosure may have a formic acid viscosity (FAV), measured according to ASTM D-789, of as low as 40 FAV, 45 FAV, 50 FAV, or as high as 80 FAV, 90 FAV, 100 FAV, or within any range defined between any two of the foregoing values, such as, for example, from 40 FAV to 100 FAV.

A dual-terminated PA resin of the present disclosure may have a relatively low extractable content as measured in accordance with ISO 6427. For example, the extractable content can be 1.0 wt. %, 0.9 wt. %, 0.8 wt. %, 0.7 wt. %, or lower, or even as low as 0.5 wt. %, 0.4 wt. %, or less, or within any range defined between any two of the foregoing values, such as from 0.9 wt. % to 0.4 wt. %, or at 0.4 wt. % or lower.

A dual-terminated PA resin of the disclosure may have a relatively low moisture level as measured in accordance to ASTM D-6869. For example, the moisture level maybe 1200 ppm, 1000 ppm, 800 ppm, or even as low as 600 ppm, 500 ppm, 400 ppm, or lower, or within any range defined between any two of the foregoing values, such as 1200 ppm to 400 ppm or less. An example of a dual-terminated PA-6 resin of the disclosure may have a moisture level of as low as 700 ppm.

A dual-terminated PA resin of the disclosure may have a Yellowness Index (YI) of less than 80, less than 50, less than 25, or less than 10 as determined per ASTM E313.

A dual-terminated PA resin of the disclosure may have a relatively high stain resistance as measured in accordance with the protocols of Red dye stain testing outlined in American Association of Textile Chemists and Colorists (AATCC) Test Method 175-08, using red dye stains with carpet fiber samples prepared from such a resin. For example, the stain resistance parameter ΔE may be less than 25, 22, or 20, or as little as, or less than, 5, 7 or 10, or within any range defined between any two of the foregoing values, such as between 5 and 20, for example.

A dual-terminated PA resin of the disclosure is thermally stable at relatively high temperatures. For example, such a resin can be stable at a temperature of 255° C., 260° C., 265° C. or even at a temperature as high as 270° C., 272° C., 275° C., or higher, or within any range defined between any two of the foregoing values, such as from 255° C. to 275° C.

A dual-terminated PA resin of the disclosure can be spun at relatively high speeds to produce fibers. For example, a dual-terminated PA resin of the disclosure can be spun to make fibers at a speed of 2500 m/min, 3000 m/min, 3500 m/min, or even as high as 4,000 m/min, 5000 m/min or 6000 m/min, or within any range defined between any two of the foregoing values, such as from 2500 m/min to 6000 m/min.

A dual-terminated PA resin of the disclosure can be spun at the typical speeds used by the floor and surface covering industry to produce carpet fibers. For example, a dual-terminated PA resin of the disclosure can be spun to produce carpet fibers at a speed of 1000 m/min, 2000 m/min, 3000 m/min, or even as high as 3100 m/min, 3300 m/min, 3500 m/min, or within any range defined between any two of the foregoing values, such as from 1000 m/min to 3500 m/min. An example of a dual-terminated PA-6 resin can be spun to make carpet fibers a speed of 1000 m/min.

A dual-terminated PA resin of the disclosure can be spun to make textile fibers having a linear mass density of 150 denier, 165 denier, 180 denier, or even as high as 250 denier, 325 denier, 400 denier, or higher, or within any range defined between any two of the foregoing values, such as from 150 denier to 400 denier.

A dual-terminated PA resin of the disclosure can be spun to make carpet fibers having a linear mass density of 1000 denier, 1100 denier, or even as high as 1400 denier, 1500 denier, or higher, or within any range defined between any two of the foregoing values, such as from 1000 denier to 1500 denier. An example of a dual-terminated PA-6 resin of the disclosure can be spun to make carpet fibers having a linear mass density of 1360 denier.

### EXAMPLES

### Example 1

### Preparation of Polyamide Polymers

Amine Termination (AEG) Samples−“Amine only terminated”:

The first set of experimental polymers included polyamides with increasing amounts of “amine termination only”. These polymers were produced by introducing acetic acid into the hydrolysis reaction step. The acetic acid terminating agent was combined with ε-caprolactam at measured quantities to achieve targeted levels of amine-end termination during the polymerization process. The polymerization process was conducted in both a lab batch reactor and multi-kettle pilot line, performing a typical polyamide synthesis reaction via hydrolysis, polyaddition, & polycondensation steps with enhanced de-gassing capabilities to promote removal of water generated from the termination reaction.

Polyamide “amine only terminated” resins samples were produced with FAV values varying between 40 and 80, and the concentration of NH₂ termination (AEG) varying between 10 mmol/kg to 35 mmol/kg. The percent of NH₂ termination (% NH₂ Termination, calculated using the equation below) varied between 30% and 85%.

$$\% NH 2 termination = [ \frac{\begin{matrix}Equilibrium NH 2 ends for FAV level - \\ Terminated NH 2 ends\end{matrix}}{Equilibrium NH 2 ends for FAV level} ] * 100 \%$$

The amine end only terminated polyamide samples are listed below in Table 1, together with their respective FAV values, molecular weights, levels of extractable (% Ext), concentrations of amino end termination, concentrations of carboxyl end termination, % total termination, % water content, % NH₂ or amino end termination, % carboxy end termination, and yellowness index (YI).

TABLE 1

| | | | | | % | % | % | |
|---|---|---|---|---|---|---|---|---|
| De- | | | NH2 | COOH | NH2 | COOH | Total | |
| scrip- | | % | mmol/ | mmol/ | Termi- | Termi- | Termi- | |
| tion | FAV | Ext | kg | kg | nation | nation | nation | YI |
| AEG | 67.9 | 0.39 | 34.3 | 49.9 | 31.4% | 0.0% | 15.8% | 5.6 |
| Term | | | | | | | | |
| Only- | | | | | | | | |
| Sam- | | | | | | | | |
| ple #1 | | | | | | | | |
| AEG | 62.8 | 0.60 | 30.7 | 53.0 | 42.1% | 0.0% | 21.0% | 7.0 |
| Term | | | | | | | | |
| Only- | | | | | | | | |
| Sam - | | | | | | | | |
| ple #2 | | | | | | | | |
| AEG | 76.6 | 0.60 | 21.7 | 47.0 | 53.8% | 0.0% | 26.9% | 7.0 |
| Term | | | | | | | | |
| Only- | | | | | | | | |
| Sam- | | | | | | | | |
| ple #3 | | | | | | | | |
| AEG | 66.8 | 0.50 | 22.1 | 52.2 | 55.8% | 0.0% | 25.7% | 7.4 |
| Term | | | | | | | | |
| Only- | | | | | | | | |
| Sam- | | | | | | | | |
| ple #4 | | | | | | | | |
| AEG | 67.3 | 0.47 | 21.8 | 53.0 | 58.9% | 0.0% | 29.4% | 8.8 |
| Term | | | | | | | | |
| Only- | | | | | | | | |
| Sam- | | | | | | | | |
| ple #5 | | | | | | | | |
| AEG | 55.3 | 0.53 | 18.4 | 56.0 | 66.5% | 0.0% | 32.4% | 9.4 |
| Term | | | | | | | | |
| Only- | | | | | | | | |
| Sam- | | | | | | | | |
| ple #6 | | | | | | | | |
| AEG | 53.4 | 0.30 | 15.8 | 57.0 | 72.3% | 0.0% | 36.1% | 8.3 |
| Term | | | | | | | | |
| Only- | | | | | | | | |
| Sam- | | | | | | | | |
| ple #7 | | | | | | | | |
| AEG | 54.4 | 0.31 | 15.2 | 57.0 | 73.3% | 0.0% | 36.7% | 9.5 |
| Term | | | | | | | | |
| Only- | | | | | | | | |
| Sam- | | | | | | | | |
| ple #8 | | | | | | | | |
| AEG | 40.2 | 0.30 | 14.5 | 65.0 | 77.7% | 0.0% | 38.8% | 12.6 |
| Term | | | | | | | | |
| Only- | | | | | | | | |
| Sam- | | | | | | | | |
| ple #9 | | | | | | | | |
| AEG | 47.7 | 0.71 | 10.0 | 55.0 | 82.1 | 0.0% | 42.0% | 12.6 |
| Term | | | | | | | | |
| Only- | | | | | | | | |
| Sam- | | | | | | | | |
| ple | | | | | | | | |
| #10 | | | | | | | | |
| AEG | 58.5 | 0.85 | 10.0 | 55.0 | 82.1% | 0.0% | 42.0% | 25.8 |
| Term | | | | | | | | |
| Only- | | | | | | | | |
| Sam- | | | | | | | | |
| ple | | | | | | | | |
| #11 | | | | | | | | |

Carboxyl Termination (CEG) Samples:

The second set of experimental polymers included polyamides with increasing amounts of “carboxyl termination only.” These polymers were produced by adding cyclohexylamine into the hydrolysis reaction step. The cyclohexylamine terminating agent was combined with ε-caprolactam at measured quantities to achieve targeted levels of carboxyl end termination during the polyamide polymerization process. The polymerization process was conducted in both a lab batch reactor and a multi-kettle pilot line, performing a typical a polyamide synthesis reaction via hydrolysis, polyaddition, and polycondensation steps with enhanced de-gassing capabilities to promote removal of water generated from the termination reaction.

Polyamide “carboxyl only terminated” resins samples were produced with varying FAV values of between 60 and 80, varying concentrations of carboxyl end termination (CEG) of between 15 mmol/kg and 40 mmol/kg. The percent of carboxyl end termination (% COOH Termination, as calculated using the equation below), varied amongst the samples at between 20% and 65%.

$$\% COOH termination = [ \frac{\begin{matrix}Equilibrium COOH ends for FAV level - \\ Terminated COOH ends\end{matrix}}{Equilibrium COOH ends for FAV level} ] * 100 \%$$

The carboxyl end only terminated polyamide samples are listed below in Table 2, together with their respective FAV values, molecular weights, levels of extractable (% Ext), concentrations of amino end termination, concentrations of carboxyl end termination, % total termination, % water content, % NH₂ or amino end termination, % carboxy end termination, and yellowness index (YI).

TABLE 2

| | | | | | % | % | % | |
|---|---|---|---|---|---|---|---|---|
| De- | | | NH2 | COOH | NH2 | COOH | Total | |
| scrip- | | % | mmol/ | mmol/ | Termi- | Termi- | Termi- | |
| tion | FAV | Ext | kg | kg | nation | nation | nation | YI |
| CEG | 67.5 | 0.46 | 44.5 | 40.5 | 0.0% | 19.0% | 15.0% | 4.6 |
| Term | | | | | | | | |
| only- | | | | | | | | |
| Sample | | | | | | | | |
| #1 | | | | | | | | |
| CEG | 66.8 | 0.44 | 45.1 | 32.2 | 0.0% | 35.4% | 22.6% | 3.6 |
| Term | | | | | | | | |
| only- | | | | | | | | |
| Sample | | | | | | | | |
| #2 | | | | | | | | |
| CEG | 73.8 | 0.42 | 45.2 | 17.2 | 0.0% | 63.4% | 33.6% | 3.2 |
| Term | | | | | | | | |
| only- | | | | | | | | |
| Sample | | | | | | | | |
| #3 | | | | | | | | |

Dual Termination (AEG & CEG) Samples—“Dual Terminated”:

The third set of experimental polymers were made with increasing concentrations of both amine end termination (AEG) and carboxyl end termination (CEG) by adding both acidic acid and cyclohexylamine into the hydrolysis reaction step. Acidic acid and cyclohexylamine terminating agents were combined with ε-caprolactam at measured quantities to achieve the targeted levels of amine and carboxyl end termination. The polymerization process was conducted in both a lab batch reactor and in a multi-kettle pilot line, performing a typical polyamide synthesis reaction via hydrolysis, polyaddition, and polycondensation steps with enhanced de-gassing capabilities to promote removal of water generated from the termination reaction.

Polyamide “amine and carboxyl dual terminated” resins samples were produced with varying FAV values of between 25 and 100, varying concentrations of amine termination (AEG) of between 5 mmol/kg and 50 mmol/kg, varying concentrations of COOH termination (CEG) of between 5 mmol/kg and 50 mmol/kg. The calculated percent of amino end and carboxyl end termination (using the equation below) varied between 30% and 85% and between 35% and 90%, respectively amongst these samples. More particularly, those dual terminated samples having FAV values between 25 and 100, and levels of total termination varying from 35% to 80% were also called “highly dual terminated.” The samples having FAV values between 40 and 50, and levels of total termination of above 80% were called “maximally dual terminated” or “Max Dual Terminated.”

$$\% Total termination = [ \frac{\begin{matrix}Equilibrium NH 2 + COOH ends for FAV level - \\ Terminated NH 2 + COOH ends\end{matrix}}{Equilibrium NH 2 + COOH ends for FAV level} ] * 100 \%$$

The dual terminated polyamide samples are listed below in Table 3, together with their respective FAV values, molecular weights, levels of extractable (% Ext), concentrations of amino end termination, concentrations of carboxyl end termination, % total termination, % water content, % NH₂ or amino end termination, % carboxy end termination, and yellowness index (YI).

TABLE 3

| | | | | COOH | %NH2 | %COOH | %Total | |
|---|---|---|---|---|---|---|---|---|
| | | | NH2 | mmol/ | Termi- | Termi- | Termi- | |
| Description | FAV | %Ext | mmol/kg | kg | nation | nation | nation | YI |
| Dual | 23.9 | 0.39 | 49.3 | 48.4 | 34.3% | 35.5% | 34.9% | 12.9 |
| Termination- | | | | | | | | |
| Sample #1 | | | | | | | | |
| Dual | 98.8 | 0.36 | 24.7 | 21.5 | 38.3% | 46.3% | 42.3% | 7.7 |
| Termination- | | | | | | | | |
| Sample #1 | | | | | | | | |
| Dual | 89.3 | 0.41 | 26.0 | 22.0 | 39.5% | 48.8% | 44.2% | 7.0 |
| Termination- | | | | | | | | |
| Sample #1 | | | | | | | | |
| Dual | 35.0 | 0.36 | 36.6 | 39.3 | 51.2% | 47.6% | 49.4% | 15.5 |
| Termination- | | | | | | | | |
| Sample #1 | | | | | | | | |
| Dual | 61.0 | 0.80 | 27.0 | 20.0 | 49.1% | 62.3% | 55.7% | −6.0 |
| Termination- | | | | | | | | |
| Commercial | | | | | | | | |
| Sample A | | | | | | | | |
| Highly Dual | 51.8 | 0.35 | 29.5 | 21.1 | 49.1% | 63.6% | 56.4% | 7.6 |
| Termination- | | | | | | | | |
| Sample #1 | | | | | | | | |
| Highly Dual | 31.4 | 0.35 | 19.3 | 46.7 | 75.9% | 41.6% | 58.8% | 14.9 |
| Termination- | | | | | | | | |
| Sample #2 | | | | | | | | |
| Highly Dual | 28.6 | 7.90 | 13.2 | 51.7 | 83.5% | 35.4% | 59.4% | −1.0 |
| Termination- | | | | | | | | |
| Sample #3 | | | | | | | | |
| Highly Dual | 35.0 | 0.60 | 25.0 | 35.0 | 66.7% | 53.3% | 60.0% | 7.0 |
| Termination- | | | | | | | | |
| Sample #4 | | | | | | | | |
| Highly Dual | 53.9 | 0.42 | 22.4 | 20.3 | 60.0% | 63.8% | 61.9% | 7.8 |
| Termination- | | | | | | | | |
| Sample #5 | | | | | | | | |
| Highly Dual | 87.2 | 0.50 | 19.3 | 7.7 | 59.8% | 84.0% | 71.9% | 11.6 |
| Termination- | | | | | | | | |
| Sample #6 | | | | | | | | |
| Max Dual | 54.5 | 0.51 | 11.2 | 11.1 | 80.0% | 80.2% | 80.1% | 15.1 |
| Termination- | | | | | | | | |
| Sample #1 | | | | | | | | |
| Max Dual | 40.8 | 0.47 | 10.5 | 16.3 | 85.0% | 76.7% | 80.9% | 12.3 |
| Termination- | | | | | | | | |
| Sample #2 | | | | | | | | |
| Max Dual | 51.9 | 0.56 | 9.0 | 11.0 | 83.9% | 80.4% | 82.1% | 12.0 |
| Termination- | | | | | | | | |
| Sample #3 | | | | | | | | |
| Max Dual | 45.2 | 0.68 | 14.5 | 8.2 | 77.7% | 87.4% | 82.5% | 10.6 |
| Termination- | | | | | | | | |
| Sample #4 | | | | | | | | |
| Max Dual | 44.8 | 0.87 | 15.9 | 6.5 | 75.5% | 90.0% | 82.8% | 10.3 |
| Termination- | | | | | | | | |
| Sample #5 | | | | | | | | |
| Max Dual | 53.1 | 0.48 | 8.4 | 10.0 | 85.0% | 82.1% | 83.6% | 11.0 |
| Termination- | | | | | | | | |
| Sample #6 | | | | | | | | |

Non-Termination and Cationic Control (CAT) Samples:

The fourth set of polymers were made to be controls, including polyamides with no termination and those acquired from commercial sources such as Cationic PA-6 resins marketed for stain resistant benefits. Polyamide that are not terminated were made using a standard polyamide polymerization process, conducted in both a lab batch reactor and a multi-kettle pilot line, performing a standard a polyamide synthesis reaction via hydrolysis, polyaddition, and polycondensation steps.

Non-Terminated polyamide resin samples were produced with varying FAV values of between 35 and 100, having typical equilibrium amine and carboxyl levels typical amine end concentrations of between 40 mmol/kg and 75 mmol/kg and carboxyl end concentrations of between 40 mmol/kg and 75 mmol/kg. Table 4 below lists the non-terminated polyamides, two lab-produced cationic PA-6 resins (R&D Samples 1 and 2), and commercial cationic PA-6 resins (Commercial Samples A and B), together with their respective FAV values, molecular weights, levels of extractable (% Ext), concentrations of amino end termination, concentrations of carboxyl end termination, % total termination, % water content, % NH₂ or amino end termination, % carboxy end termination, and yellowness index (YI).

TABLE 4

| | | | NH2 | COOH | VoNH2 | %COOH | %Total | |
|---|---|---|---|---|---|---|---|---|
| | | | mmol/ | mmol/ | Termi- | Termi | Termi- | |
| Description | FAV | %Ext | kg | kg | nation | nation | nation | YI |
| Non-Terminated- | 76.7 | 0.42 | 48.3 | 50.3 | 0.0% | 0.0% | 0.0% | 6.5 |
| Sample #1 | | | | | | | | |
| Non-Terminated- | 69.0 | 0.60 | 49.0 | 49.0 | 0.0% | 0.0% | 0.0% | 18.3 |
| Sample #2 | | | | | | | | |
| Non-Terminated- | 101.0 | 0.29 | 40.0 | 40.0 | 0.0% | 0.0% | 0.0% | 29.5 |
| Sample #3 | | | | | | | | |
| Non-Terminated- | 55.0 | 0.70 | 55.0 | 55.0 | 0.0% | 0.0% | 0.0% | −4.0 |
| Commercial | | | | | | | | |
| Sample A | | | | | | | | |
| Non-Terminated- | 35.0 | 0.70 | 73.0 | 73.0 | 0.0% | 0.0% | 0.0% | −5.0 |
| Commercial | | | | | | | | |
| Sample B | | | | | | | | |
| Competitive | 55.0 | 0.60 | 10.0 | 55.0 | 81.8% | 0.0% | 40.9% | −2.0 |
| Cationic | | | | | | | | |
| Control #1 | | | | | | | | |
| Competitive | 45.0 | 0.50 | 8.5 | 65.0 | 86.9% | 0.0% | 43.5% | −1.0 |
| Cationic | | | | | | | | |
| Control #2 | | | | | | | | |
| Cationic R&D | 41.0 | 0.70 | 8.9 | 68.0 | 86.9% | 0.0% | 43.5% | 11.0 |
| Sample #1 | | | | | | | | |
| Cationic R&D | 62.5 | 0.65 | 16.6 | 53.0 | 68.7% | 0.0% | 34.3% | 11.0 |
| Sample #2 | | | | | | | | |

### Example 2

### Preparation of Fiber Samples

The dual-terminated polyamide resins of the disclosure are useful when spun into fibers that can then be weaved into textile fabrics or carpet fibers, and the resin samples prepared in accordance with the protocols as provided in Example 1 are further processed using melt extrusion into fibers for end uses such as fabrics or carpets. The conditions under which the terminated or non-terminated control resins of Example 1 were processed into suitable fibers for such downstream uses are listed below in Table 5.

TABLE 5
Processing Conditions for Fibers Samples

| End Use Application | Textile | | Carpet Fibers | |
|---|---|---|---|---|
| Fiber Type | Flat Yarn | | Textured Crimp | |
| Thruputs: | 15.0 | pph | 20.0 | pph |
| Extruder Temps ° C. | 255-265 | | 260-265 | |
| Speeds: | 2500 to 6000 | mpm | 1000 to 2500 | mpm |
| Shear: | 8500-9000 | sec−1 | 4000-6000 | sec−1 |

| Spin Stack/Melt Draw: | 95-230X | 50-75X |
|---|---|---|
| Mechanical Draw: | 1X | 3.0-3.3X |
| X-Section: | Round | Delta |
| | | (MR = 1.5-1.8) |
| Denier/# Fils: | 150 d/36 f, 180 | 1360 d/48 f, 1360 |
| | d/36 f (4-5 dpf) | d/60 f (22-28 dpf) |
| | 230 d/36 f, 370 | |
| | d/36 f (6-10 dpf) | |

| | | |
|---|---|---|
| Finish OOY: | 1.0- | 1.0- |
| | 1.2% | 1.2% |
| Texturing: | N/A | Hot Air Texture |
| | | w/cooling drum |
| Entanglement: | N/A | Air Entanglement |
| | | Jet |

### Example 3

### Evaluation of Polyamide Polymers and Fibers Produced Therefrom for Stain Resistance

Leached & dried terminated, non-terminated control, and commercial polyamide resin pellets were subject to red dye stain testing.

To prepare the red dye staining solution, 100 mg of FD&C Red 40 dye was measured out and dissolved in about 200 mL of water in a 1000-mL beaker to form a mixture. The mixture in the beaker was then adjusted to a pH of 2.8+/−0.1 using citric acid.

Resin pellets were placed in a glass dish and the Red Dye 40 staining solution was poured onto the pellets. The pellets were exposed to the staining solution as they sat in the glass dish for 15 minutes. Afterwards, the pellets were rinsed and transferred into clean glass dishes. The pellets were then placed in a vacuum oven overnight to dry, where the vacuum oven was set to operate at a temperature of 90° C. A colorimeter was used to measure the staining of the resin pellets using the standard Hunter L,a,b color scale. Standard ΔE values were calculated based on the color reading obtained from the leached, dried, stained, washed, further dried resin pellets using the equation below:

Standard ΔE=((ΔL\hat{ }2)+(Δa\hat{ }2)+(Δb\hat{ }2))\hat{ }1/2).

Standard ΔE is a parameter measuring color change due to dye uptake/stain level. Table 6 below shows various terminated, non-terminated control, commercial benchmark polyamide, compound blended polyamides, and Table 6-2 lists certain polyamide mixtures with stain-resistance masterbatch formulations in FAV values, termination concentrations and levels (% AEG or % CEG, or % Term), and the ΔE values calculated from colorimetric measurements of the resins or the fibers made therefrom

TABLE 6

| | | | | | | | | Delta | Delta | Delta |
|---|---|---|---|---|---|---|---|---|---|---|
| | | | | | | | Delta E | E W & | E | E |
| | FA | AE | CE | %AE | %CE | %Ter | Compounded | D | Textile | Carpet |
| Polymer | V | G | G | G | G | m | Resin | Resin | Fiber | Fiber |
| Non- | 55 | 55 | 55 | 0 | 0 | 0 | 57.1 | 42.6 | 52.5 | 28.8 |
| Termi- | | | | | | | | | | |
| nated | | | | | | | | | | |
| PA-6 | | | | | | | | | | |
| CEG | 74 | 48 | 17 | 0 | 64 | 32 | 47.2 | 36.0 | 40.1 | 25.2 |
| Mono | | | | | | | | | | |
| Termi- | | | | | | | | | | |
| nated | | | | | | | | | | |
| PA-6 | | | | | | | | | | |
| AEG | 55 | 18 | 56 | 67 | 0 | 41 | 42.7 | 24.0 | 33.4 | 24.8 |
| Mono | | | | | | | | | | |
| Termi- | | | | | | | | | | |
| nated | | | | | | | | | | |
| PA-6 | | | | | | | | | | |
| MBM | 61 | 27 | 20 | 51 | 64 | 56 | 46.3 | 24.9 | 32.0 | 24.1 |
| Dual | | | | | | | | | | |
| Termi- | | | | | | | | | | |
| nated | | | | | | | | | | |
| PA-6 | | | | | | | | | | |
| High | 54 | 22 | 20 | 60 | 64 | 62 | 44.7 | | 27.5 | 21.5 |
| Dual | | | | | | | | | | |
| Termi- | | | | | | | | | | |
| nated | | | | | | | | | | |
| PA-6 | | | | | | | | | | |
| Max | 55 | 8 | 10 | 91 | 82 | 86 | 14.1 | 7 | | 10.3 |
| Dual | | | | | | | | | | |
| Termi- | | | | | | | | | | |
| nated | | | | | | | | | | |
| PA-6 | | | | | | | | | | |
| Non- | 64 | 50 | 50 | 17 | 0 | 9 | | | | 9.5 |
| Termi- | | | | | | | | | | |
| nated | | | | | | | | | | |
| PA-6 + | | | | | | | | | | |
| 20% | | | | | | | | | | |
| Cationic | | | | | | | | | | |
| PA-6 | | | | | | | | | | |
| Blend | | | | | | | | | | |
| High | 54 | 19 | 20 | 65 | 64 | 64 | | | 11.3 | 5.2 |
| Dual | | | | | | | | | | |
| Termi- | | | | | | | | | | |
| nated | | | | | | | | | | |
| PA-6 + | | | | | | | | | | |
| 20% | | | | | | | | | | |
| Cationic | | | | | | | | | | |
| PA-6 | | | | | | | | | | |
| Blend | | | | | | | | | | |
| 100% | 55 | 10 | 55 | 82 | 0 | 41 | | 2.9 | 4.1 | 1.8 |
| Cationic | | | | | | | | | | |
| PA-6 | | | | | | | | | | |

The above results clearly indicated that highest dye uptake/staining or ΔE were results of staining for non-terminated polyamide resins and fibers produced therefrom. Increasing % Termination, either by increasing % AEG, or % CEG or both % AEG and % CEG at the same time resulted in resins or fibers of lower dye uptake/staining or ΔE values. Between amino end termination and carboxyl end termination, it appeared that amino end termination alone had a higher impact than carboxyl end termination alone on the resins/fibers' ability to resist dye uptake or staining.

### Example 4: Evaluation of Resin Samples' Melt FAV Build Stability

The parameter “melt FAV stability” was tested for the various resin samples prepared in accordance with Example 1, including terminated polyamide resins, and non-terminated polyamide resins as controls. Melt stability samples were generated from each resin sample, using a melt flow tester. The polyamide resin samples were thereafter extracted at 10 minute intervals (or between 10 minutes to 60 minutes) to measure FAV/molecular weight change due to increasing melt residence time exposure vs original resin FAV control sample (which had a resident time of 0 minute). The FAV values of melt stability samples were measured using standard ASTM D-789 formic acid viscosity testing method. Table 7 below lists the results obtained.

TABLE 7
Melt Stability FAV Values of Terminated and Control Polyamide Resins

| | | | | % Termi- | %AEG | %CEG | FAV @ Residence Time (min) | | | | | | |
|---|---|---|---|---|---|---|---|---|---|---|---|---|---|
| Polymer | FAV | AEG | CEG | nation | Term | Term | 0 | 10 | 50 | 20 | 60 | 30 | 40 |
| Non- | 55.0 | 55.0 | 55.0 | 0.%0 | 0.0% | 0.0% | 55.0 | 58.0 | 61.0 | 63.5 | 66.7 | 70.1 | 72.9 |
| Terminated | | | | | | | | | | | | | |
| PA-6 | | | | | | | | | | | | | |
| AGE Mono | 58.0 | 38.0 | 55.0 | 15.5% | 30.9% | 0.0% | 58.0 | 59.5 | 60.5 | 62.1 | 63.8 | 65.3 | 66.7 |
| Terminated | | | | | | | | | | | | | |
| PA-6- | | | | | | | | | | | | | |
| Producer A | | | | | | | | | | | | | |
| AEG Mono | 41.7 | 46.7 | 71.8 | 17.7% | 35.0% | 0.0% | 41.7 | 42.8 | 43.3 | 44.0 | 46.2 | 46.8 | 48.5 |
| Terminated | | | | | | | | | | | | | |
| PA-6- | | | | | | | | | | | | | |
| Producer B | | | | | | | | | | | | | |
| High AEG | 55.3 | 18.4 | 56.0 | 32.7% | 66.5% | 0.0% | 55.3 | 55.7 | 55.9 | 56.0 | 57.1 | 57.3 | 58.0 |
| Mono | | | | | | | | | | | | | |
| Terminated | | | | | | | | | | | | | |
| PA-6 | | | | | | | | | | | | | |
| MBM Dual | 61.0 | 27.0 | 20.0 | 57.3% | 50.9% | 63.6% | 61.0 | 61.3 | 61.4 | 61.8 | 61.7 | 62.5 | 62.6 |
| Terminated | | | | | | | | | | | | | |
| PA-6 | | | | | | | | | | | | | |
| Max Dual | 44.8 | 15.9 | 6.5 | 82.8% | 77.3% | 90.7% | 44.8 | 44.9 | 45.0 | 45.2 | 45.0 | 45.5 | 45.6 |
| Terminated | | | | | | | | | | | | | |
| PA-6 | | | | | | | | | | | | | |

Rate Change of Melt Stability Delta FAV with Residence Time

| | | | | % Termi- | %AEG | %CEG | FAV @ Residence Time (min) | | | | | | |
|---|---|---|---|---|---|---|---|---|---|---|---|---|---|
| Polymer | FAV | AEG | CEG | nation | Term | Term | 0 | 10 | 20 | 30 | 60 | 40 | 50 |
| Non- | 55.0 | 55.0 | 55.0 | 0.0% | 0.0% | 0.0% | 0 | 3.0 | 6.0 | 8.5 | 11.7 | 15.1 | 17.9 |
| Terminated | | | | | | | | | | | | | |
| PA-6 | | | | | | | | | | | | | |
| AGE Mono | 58.0 | 38.0 | 55.0 | 15.5% | 30.9% | 0.0% | 0 | 1.5 | 2.5 | 4.1 | 5.8 | 7.3 | 8.7 |
| Terminated | | | | | | | | | | | | | |
| PA-6- | | | | | | | | | | | | | |
| Producer A | | | | | | | | | | | | | |
| AEG Mono | 41.7 | 46.7 | 71.8 | 17.7% | 35.0% | 0.0% | 0 | 1.1 | 1.6 | 2.4 | 4.5 | 5.1 | 6.8 |
| Terminated | | | | | | | | | | | | | |
| PA-6- | | | | | | | | | | | | | |
| Producer B | | | | | | | | | | | | | |
| High AEG | 55.3 | 18.4 | 56.0 | 32.7% | 66.5% | 0.0% | 0 | 0.4 | 0.6 | 0.9 | 1.8 | 2.0 | 2.7 |
| Mono | | | | | | | | | | | | | |
| Terminated | | | | | | | | | | | | | |
| PA-6 | | | | | | | | | | | | | |
| MBM Dual | 61.0 | 27.0 | 20.0 | 57.3% | 50.9% | 63.6% | 0 | 0.3 | 0.4 | 0.8 | 0.7 | 1.5 | 1.6 |
| Terminated | | | | | | | | | | | | | |
| PA-6 | | | | | | | | | | | | | |
| Max Dual | 44.8 | 15.9 | 6.5 | 82.8% | 77.3% | 90.7% | 0 | 0.1 | 0.2 | 0.4 | 0.3 | 0.7 | 0.8 |
| Terminated | | | | | | | | | | | | | |
| PA-6 | | | | | | | | | | | | | |

These results clearly indicate that the non-terminated polyamide resins had the highest polymer FAV growth with increased melt residence time. As the % Term increases (achieved through increasing % AEG, increasing % CEG, or increasing both % AEG and % CEG at the same time), the FAV growth with increasing melt residence time measurably decreases. As such, better melt-stability results were achieved through higher levels of total termination on the polyamide resin.

In Tables 8 and 9 below, parameters of fitted line plots of the data are provided. Statistical analyses indicate that, between % AEG and % CEG, % AEG has a much greater contribution or effect to melt FAV growth stability (such as greater than 90%) than % CEG, when a dual-terminated polyamide was made and tested. In contrast, the contribution of % AEG towards melt FAV stability would be less than 10%.

TABLE 8
Polynomial Regression Analysis: 60 versus % Termination
The regression equation is
60 = 19.08 − 88.25 % Terminal + 148.5 %
Termination\hat{ }2 − 82.84 % Termination\hat{ }3
Model Summary

| S | R-sq | R-sq(adj) |
|---|---|---|
| 0.884968 | 98.84% | 98.26% |

Analysis of Variance

| Source | DF | SS | MS | F | P |
|---|---|---|---|---|---|
| Regression | 3 | 400.594 | 133.531 | 170.50 | 0.000 |
| Error | 6 | 4.699 | 0.783 | | |
| Total | 9 | 405.293 | | | |

Sequential Analysis of Variance

| Source | DF | SS | F | P |
|---|---|---|---|---|
| Linear | 1 | 289.301 | 19.95 | 0.002 |
| Quadratic | 1 | 94.457 | 30.70 | 0.001 |
| Cubic | 1 | 16.836 | 21.50 | 0.004 |

TABLE 9
Polynomial Regression Analysis: 60 versus % AEG Term
The regression equation is
60 = 19.08 − 28.71 % AEG Term − 51.90 %
AEG Term\hat{ }2 + 68.92 % AEG Term\hat{ }3
Model Summary

| S | R-sq | R-sq(adj) |
|---|---|---|
| 1.54521 | 96.47% | 94.70% |

Analysis of Variance

| Source | DF | SS | MS | F | P |
|---|---|---|---|---|---|
| Regression | 3 | 390.967 | 130.322 | 54.38 | 0.000 |
| Error | 6 | 14.326 | 2.388 | | |
| Total | 9 | 405.293 | | | |

Sequential Analysis of Variance

| Source | DF | SS | F | P |
|---|---|---|---|---|
| Linear | 1 | 359.464 | 62.75 | 0.000 |
| Quadratic | 1 | 28.024 | 11.02 | 0.013 |
| Cubic | 1 | 3.479 | 1.46 | 0.273 |

### Example 5: Evaluation of Resin Samples' Melt % Extractables Rebuild Stability

The parameter “melt % extractables/C1 rebuild stability” was tested for the various polymer resin samples prepared in accordance with Example 1, including terminated and non-terminated control samples. Melt stability samples were generated from such resin samples, using a melt flow tester. Those samples were then extracted in 10 minute intervals (or between 10 minutes and 60 minutes) to measure % extractables/% C1 change due to increasing melt residence time exposure versus original polymer resin % extractables/% C1 control sample (which has been exposed to a melt resident time of 0 minute). Table 10 below shows lists the results obtained.

TABLE 10
Melt %Extractables/C1 Rebuild Stability of Terminated and Control Polyamide Resins

| | | | | % Termi- | %AEG | %CEG | Ext @ Residence Time (min) | | | | | | |
|---|---|---|---|---|---|---|---|---|---|---|---|---|---|
| Polymer | FAV | AEG | CEG | nation | Term | Term | 0 | 10 | 50 | 20 | 60 | 30 | 40 |
| Non- | 55.0 | 55.0 | 55.0 | 0.0% | 0.0% | 0.0% | 0.73 | 1.51 | 1.87 | 2.24 | 2.57 | 2.89 | 3.34 |
| Termi- | | | | | | | | | | | | | |
| nated | | | | | | | | | | | | | |
| PA-6 | | | | | | | | | | | | | |
| AEG | 57.6 | 38.0 | 55.0 | 15.5% | 30.9% | 0.0% | 0.58 | 1.15 | 1.25 | 1.44 | 1.61 | 1.91 | 2.42 |
| Mono | | | | | | | | | | | | | |
| Termi- | | | | | | | | | | | | | |
| nated | | | | | | | | | | | | | |
| PA-6- | | | | | | | | | | | | | |
| Producer | | | | | | | | | | | | | |
| A | | | | | | | | | | | | | |
| High | 55.3 | 18.4 | 56.0 | 32.4% | 66.5% | 0.0% | 0.53 | 1.09 | 1.19 | 1.28 | 1.31 | 1.35 | 1.39 |
| AEG | | | | | | | | | | | | | |
| Mono | | | | | | | | | | | | | |
| Termi- | | | | | | | | | | | | | |
| nated | | | | | | | | | | | | | |
| PA-6 | | | | | | | | | | | | | |
| MBM | 61.0 | 27.0 | 20.0 | 55.7% | 50.9% | 63.6% | 0.83 | 1.28 | 1.36 | 1.42 | 1.45 | 1.47 | 1.49 |
| Dual | | | | | | | | | | | | | |
| Termi- | | | | | | | | | | | | | |
| nated | | | | | | | | | | | | | |
| PA-6 | | | | | | | | | | | | | |
| Max | 44.8 | 15.9 | 6.5 | 82.8% | 77.3% | 90.7% | 0.78 | 1.06 | 1.10 | 1.14 | 1.14 | 1.15 | 1.15 |
| Dual | | | | | | | | | | | | | |
| Termi- | | | | | | | | | | | | | |
| nated | | | | | | | | | | | | | |
| PA-6 | | | | | | | | | | | | | |

Change of Melt %Extractables/C1 Rebuild Stability with Residence Time

| | | | | % Termi- | %AEG | %CEG | Delta Ext Change @ Residence Time (min) | | | | | | |
|---|---|---|---|---|---|---|---|---|---|---|---|---|---|
| Polymer | FAV | AEG | CEG | nation | Term | Term | 0 | 10 | 20 | 50 | 30 | 60 | 40 |
| Non- | 55.0 | 55.0 | 55.0 | 0.0% | 0.0% | 0.0% | 0.00 | 0.78 | 1.14 | 1.51 | 1.84 | 2.16 | 2.62 |
| Termi- | | | | | | | | | | | | | |
| nated | | | | | | | | | | | | | |
| PA-6 | | | | | | | | | | | | | |
| AEG | 57.6 | 38.0 | 55.0 | 15.5% | 30.9% | 0.0% | 0.00 | 0.57 | 0.67 | 0.86 | 1.03 | 1.33 | 1.84 |
| Mono | | | | | | | | | | | | | |
| Termi- | | | | | | | | | | | | | |
| nated | | | | | | | | | | | | | |
| PA-6- | | | | | | | | | | | | | |
| Producer | | | | | | | | | | | | | |
| A | | | | | | | | | | | | | |
| High | 55.3 | 18.4 | 56.0 | 32.4% | 66.5% | 0.0% | 0.00 | 0.56 | 0.71 | 0.75 | 0.78 | 0.82 | 0.86 |
| AEG | | | | | | | | | | | | | |
| Mono | | | | | | | | | | | | | |
| Termi- | | | | | | | | | | | | | |
| nated | | | | | | | | | | | | | |
| PA-6 | | | | | | | | | | | | | |
| MBM | 61.0 | 27.0 | 20.0 | 55.7% | 50.9% | 63.6% | 0.00 | 0.46 | 0.53 | 0.59 | 0.62 | 0.65 | 0.66 |
| Dual | | | | | | | | | | | | | |
| Termi- | | | | | | | | | | | | | |
| nated | | | | | | | | | | | | | |
| PA-6 | | | | | | | | | | | | | |
| Max | 44.8 | 15.9 | 6.5 | 82.8% | 77.3% | 90.7% | 0.00 | 0.28 | 0.32 | 0.36 | 0.36 | 0.37 | 0.37 |
| Dual | | | | | | | | | | | | | |
| Termi- | | | | | | | | | | | | | |
| nated | | | | | | | | | | | | | |
| PA-6 | | | | | | | | | | | | | |

As shown in Table 10, the highest rate of melt % extractables/C1 rebuild stability change was observed with non-terminated polyamide resin control sample. A measurable reduction in the rate of % extractables/C1 rebuild stability was observed with increasing % Term (or levels of total termination), achieved through increasing amino-end termination, increasing carboxyl-end termination, or both increasing amino-end termination and carboxyl-end termination at the same time.

In Tables 11 and 12 below, parameters of fitted line plots of the same data in Table 10 are provided. Statistical analyses indicate that, between % AEG and % CEG, % AEG has a much greater contribution or effect to melt % extractables/C1 rebuild stability (such as greater than 80%) than % CEG, when a dual-terminated polyamide was made and tested. In contrast, the contribution of % AEG towards melt % extractables/C1 rebuild stability would be less than 20%.

TABLE 11
Polynomial Regression Analysis: 60 versus % Termination
The regression equation is
60 = 2.838 − 9.224 % Termination + 13.33 %
Termination\hat{ }2 − 6.972 % Termination 3
Model Summary

| S | R-sq | R-sq(adj) |
|---|---|---|
| 0.261243 | 95.32% | 92.98% |

Analysis of Variance

| Source | DF | SS | MS | F | P |
|---|---|---|---|---|---|
| Regression | 3 | 8.33526 | 2.77842 | 40.71 | 0.000 |
| Error | 6 | 0.40949 | 0.06825 | | |
| Total | 9 | 8.74475 | | | |

Sequential Analysis of Variance

| Source | DF | SS | F | P |
|---|---|---|---|---|
| Linear | 1 | 7.16737 | 36.35 | 0.000 |
| Quadratic | 1 | 1.04947 | 13.92 | 0.007 |
| Cubic | 1 | 0.11842 | 1.74 | 0.236 |

TABLE 12
Polynomial Regression Analysis: 60 versus % AEG Term
The regression equation is
60 = 2.829 − 1.087 % AEG Term − 11.32 %
AEG Term\hat{ }2 + 11.47 % AEG Term\hat{ }3
Model Summary

| S | R-sq | R-sq(adj) |
|---|---|---|
| 0.324555 | 92.77% | 89.16% |

Analysis of Variance

| Source | DF | SS | MS | F | P |
|---|---|---|---|---|---|
| Regression | 3 | 8.11273 | 2.70424 | 25.67 | 0.001 |
| Error | 6 | 0.63201 | 0.10534 | | |
| Total | 9 | 8.74475 | | | |

Sequential Analysis of Variance

| Source | DF | SS | F | P |
|---|---|---|---|---|
| Linear | 1 | 7.88990 | 73.84 | 0.000 |
| Quadratic | 1 | 0.11815 | 1.12 | 0.325 |
| Cubic | 1 | 0.10468 | 0.99 | 0.357 |

### Example 6: Evaluating the Effects of Termination on Polyamide Fibers' Processability and Other Properties

Hills Pre-Oriented Yarn/Fully Drawn Yarn (POI/FRY) Textile Fibers spinning evaluations were conducted on experimental fiber samples made from terminated polyamide, non-terminated, and commercial/competitive control samples. Additional fiber samples were made from blending base terminated or non-terminated resins with a polyester-based, commercially available stain resist masterbatch additive and spun into 150-370d/36f POY and FDY fibers for stain testing.

POY/FDY textile fibers spinning process comprised of extruding polymer pellets via typical single screw extrusion (2″ diameter screw: 27 to 1 L/D with mixing) at a thruput of 15 pph with zone temperatures set between 255° C. and 265° C. and an extruder pressure of 750 psig (with capillary shear of between 8500 sec⁻¹ and 9000 sec⁻¹). Fiber was spun using spinnerets with a round cross-section (x-section) of 0.4 mm diameter capillaries via cross flow air quenching (40% flow & 75° F./50% RH conditions) to produce 150-370 denier/36 filaments fiber samples. All experimental and control polymer samples were assessed for spinning processing performance via take up speeds of between 2500 and 6000 m/min and stack draw ratios from 95× to 230× creating range of POY partial-oriented-yarn & FDY full draw yarn samples for testing.

As shown in Table 13, POY/FDY Textile Fibers spinning evaluations showed improved spinning processing performance and resulting fiber tenacities for fibers made from dual-terminated, especially highly-dual terminated, polyamide resins, as compared to the non-terminated resins/controls, especially when the spinning speeds are high, e.g., of up 6000 m/min. Significantly fewer to no filament breaks were observed at such high spinning speeds. To that end, the poorest processability and resulting fiber performance were observed with non-terminated resins, with clearly notable numbers of filament breaks at significant lower spinning speeds of about 4500 and 5000 m/min.

The addition of the polyester-based stain-resistance masterbatch additive markedly reduced fiber spinning processability in both the terminated and non-terminated polyamide resins, especially when the masterbatch had a higher loading, e.g., >4. It was further noted that that the negative impact of the stain-resistance masterbatch additive was particularly prominent on non-terminated polyamide resin controls, even at very low loading, resulting in large number of filament breaks and reducing the maximum usable spinning speed to less than 4000 m/min.

If the stain-resistance masterbatch additive is used to make a non-terminated polyamide resin having a reasonable level of stain resistance, e.g., a ΔE of less than 10, that resin cannot be spun at a speed greater than about 3000 m/min, and even at 3000 m/min, very large numbers of filament breaks occur. In contrast, a highly dual-terminated resin sample (#5 of Table 13) was able to achieve ΔE of less than 10 with less than about 2% of the same stain-resistance masterbatch, which allows the spinning to be conducted at a speed of about 5000 m/min without any observed filament breaks. The filament break counts of Table 13 was taken from a 5-minute period of spinning at the listed speeds.

TABLE 13

| | | | | | % | | | | | |
|---|---|---|---|---|---|---|---|---|---|---|
| | | | | % | Strain | Spinning speed* | | | | |
| | FAV | NH2 | COOH | Term | MB | 3000 | 4000 | 5000 | 5500 | 6000 |
| Dual terminated | 61 | 27 | 20 | 56 | 0 | 0 | 0 | 0 | 0 | 1 |
| Commercial | | | | | | | | | | |
| Sample A | | | | | | | | | | |
| AEG Terminated | 50 | 15 | 57 | 38 | 0 | 0 | 0 | 0 | 2 | 2 |
| Only Sample #8 | | | | | | | | | | |
| AEG Terminated | 51 | 16 | 57 | 36 | 0 | 0 | 0 | 1 | 2 | 3 |
| Only-Sample #7 | | | | | | | | | | |
| AEG Terminated | 55 | 18 | 54 | 32 | 0 | 0 | | 1 | 2 | 2 |
| Only-Sample #6 | | | | | | | | | | |
| AEG Terminated | 67 | 22 | 52 | 24 | 0 | 0 | 0 | 2 | 3 | 5 |
| Only-Sample #4 | | | | | | | | | | |
| Highly Dual | 54 | 22 | 20 | 62 | 0 | 0 | 0 | 0 | 0 | 1 |
| Terminated- | | | | | | | | | | |
| Sample #5 | | | | | | | | | | |
| Highly Dual | 54 | 22 | 20 | 62 | 1 | 0 | 0 | 0 | 2 | 2 |
| Terminated- | | | | | | | | | | |
| Sample #5 + Stain | | | | | | | | | | |
| MB 1% | | | | | | | | | | |
| Highly Dual | 54 | 22 | 20 | 62 | 2 | 0 | 0 | 0 | 2 | 4 |
| Terminated- | | | | | | | | | | |
| Sample #5 + Stain | | | | | | | | | | |
| MB 2% | | | | | | | | | | |
| Highly Dual | 54 | 22 | 20 | 62 | 4 | 0 | 1 | 3 | 7 | — |
| Terminated- | | | | | | | | | | |
| Sample #5 + Stain | | | | | | | | | | |
| MB 4% | | | | | | | | | | |
| Highly Dual | 55 | 18 | 54 | 32 | 8 | 5 | 15/B | — | — | — |
| Terminated- | | | | | | | O | | | |
| Sample #6 + Stain | | | | | | | | | | |
| MB 8% | | | | | | | | | | |
| Non-terminated- | 55 | 55 | 55 | 0 | 0 | 0 | 0 | 4 | 9 | — |
| Sample A | | | | | | | | | | |
| Non-terminated- | 55 | 55 | 55 | 0 | 1 | 0 | 5 | 8 | 14 | — |
| Sample A + Stain | | | | | | | | | | |
| MB 1% | | | | | | | | | | |
| Non-terminated- | 55 | 55 | 55 | 0 | 1 | 2 | 0 | 9 | 12 | 21/B |
| Sample A +Stain | | | | | | | | | | O |
| MB 2% | | | | | | | | | | |
| Non-terminated- | 50 | 58 | 58 | 0 | 4 | 4 | 9 | 16 | — | — |
| Sample A +Stain | | | | | | | | | | |
| MB 4% | | | | | | | | | | |
| Non-terminated- | 50 | 58 | 58 | 0 | 8 | 12/BO | — | — | — | — |
| Sample A +Stain | | | | | | | | | | |
| MB 8% | | | | | | | | | | |
| Competitive | 55 | 14 | 55 | 37 | 0 | 0 | 1 | 4 | 10 | — |
| Cationic Cntrl #1 | | | | | | | | | | |

*Values of 0-2 are rated as good;
3-6 are marginal;
7 or greater is unacceptable

Hills POY/FDY Textile Fibers from spinning trials were also tested for denier, x-section, % FOY Finish-on-Yarn, & tensile properties (Tenacity & % Elongation). The highest tenacities (e.g., between 4.5 and 5.0 gpd) as measured in the fiber tensile testing were achieved with terminated resins.

It was noted that addition of stain-resistance masterbatch additive significantly reduced the resulting fiber tenacities in both terminated and non-terminated polymers. Similar to what was observed with spinning processability, however, the negative impact of the stain-resistance masterbatch additive was more pronounced for non-terminated polyamide resins than for terminated polyamide resins. The tenacities of fibers produced from non-terminated resins mixed with an effective amount of stain-resistance masterbatch ranged from about 3.3 and 3.6 gpd, whereas the tenacities fibers produced from terminated resins mixed with an effective amount of stain-resistance masterbatch was between about 3.8 and 4.3 gpd.

While this invention has been described as relative to exemplary designs, the present invention may be further modified within the spirit and scope of this disclosure. Further, this application is intended to cover such departures from the present disclosure as come within known or customary practice in the art to which this invention pertains.

1. A polyamide polymer having amine end groups and carboxyl end groups, the polyamide polymer further comprising:
an amine end group concentration less than 20 mmol/kg;
a carboxyl end group concentration less than 20 mmol/kg; and
a formic acid viscosity (FAV) of at least 40 as measured according to ASTM D-789.

2. The polyamide polymer of claim 1, wherein the polyamide polymer has an amine end group concentration of between 8 mmol/kg and 20 mmol/kg.

3. The polyamide polymer of claim 1, wherein the polyamide polymer has a carboxyl end group concentration of between 6 mmol/kg and 20 mmol/kg.

4. The polyamide polymer of claim 1, wherein the polyamide polymer has a formic acid viscosity (FAV) of at least 50 as measured according to ASTM D-789.

5. The polyamide polymer of claim 1, wherein the polyamide polymer has a formic acid viscosity between 40 and 90 as measured according to ASTM D-789.

6. The polyamide polymer of claim 1, wherein the polyamide polymer has an extractables content of less than 1.0 wt. % as measured according to ISO 6427.

7. The polyamide polymer of claim 1, wherein the polyamide polymer has a □E according to AATCC Test Method 175-08 of less than 10.

8. The polymer of claim 1, wherein the polyamide polymer is polycaprolactam.

9. A method of forming a polyamide polymer fiber, comprising the steps of:
providing a polyamide polymer having amine end groups and carboxyl end groups, the polyamide polymer further comprising:
an amine end group concentration less than 20 mmol/kg;
a carboxyl end group concentration less than 20 mmol/kg; and
a formic acid viscosity (FAV) of at least 40 as measured according to ASTM D-789; and
spinning the polyamide polymer at a spinning speed of at least 2,500 m/min to form a plurality of fibers.

10. The method of claim 9, wherein said spinning step comprises spinning the polyamide polymer at a spinning speed of between 2,500 m/min and 5,000 m/min to form a plurality of fibers.

11. The method of claim 9, wherein the fibers have a □E according to AATCC Test Method 175-08 of less than 22.

12. The method of claim 9, wherein the polyamide polymer of said providing step is polycaprolactam.

13. The method of claim 9, wherein the polyamide polymer of said providing step has an amine end group concentration of between 8 mmol/kg and 20 mmol/kg.

14. The method of claim 9, wherein the polyamide polymer of said providing step has a carboxyl end group concentration of between 6 mmol/kg and 20 mmol/kg.

15. The method of claim 9, wherein the polyamide polymer of said providing step has a formic acid viscosity between 40 and 90 as measured according to ASTM D-789.

16. The method of claim 9, wherein the polyamide polymer of said providing step has an extractables content of less than 1.0 wt. % as measured according to ISO 6427.
